(19) United States
(12) Patent Application Publication
(10) Pub. No.: US 2001/0030275 A1
(43) Pub. Date: Oct. 18, 2001

(54) Tremble correcting device

(75) Inventors: Shinji Tsukamoto, Saitama (JP); Ken Hirunuma, Tokyo (JP); Koji Tsuda, Saitama (JP)

Correspondence Address: GREENBLUM & BERNSTEIN, P.L.C., 1941 ROLAND CLARKE PLACE, RESTON, VA, 20191, US

(73) Assignee: ASAHI KOGAKU KOGYO KABUSHIKI KAISHA, Tokyo (JP)

(21) Appl. No.: 09/833,611

(22) Filed: Apr. 13, 2001

(30) Foreign Application Priority Data
Apr. 18, 2000 (JP) P2000-116237

(51) Int. Cl. G02B 27/40

(52) U.S. Cl. 250/201.2

(57) ABSTRACT

Binoculars are provided with correction lenses for correcting a tremble of a focused image and stepping motors which unitarily move the correction lenses. With respect to a lengthwise direction, a sensor detects an angular speed of a tremble of optical axes of the binoculars. After being amplified and converted to digital data, output of the sensor is input to the microcomputer. Based on the angular speed, the microcomputer calculates a necessary pulse number of driving pulse signals. The necessary pulse number indicates the number of pulses to be applied to the stepping motor in order to correct the tremble. Based on the necessary pulse number, a circuit selects one pulse group among pulse groups of different pulse rates. The circuit outputs the selected pulse group to a motor driver which drives the stepping motor for a predetermined period. With respect to a lateral direction, similar operations are carried out.

### BACKGROUND OF THE INVENTION

1. Field of the Invention

This invention relates to a tremble correcting device which prevents a tremble of a focused image caused by a hand tremble in an optical device, for example a pair of binoculars.

2. Description of the Related Art

Conventionally, in the field of an optical device, for example a pair of binoculars, a product is improved, by providing it with a function which corrects a focused optical image tremble caused by a hand tremble. When the focused image tremble is corrected, it is recognized that the tremble is a deviation of the optical axis of the optical device from the subject being view. The optical device is provided with sensors which detect a direction and an angular speed of movement of the optical axis due to the hand tremble, and correction optical systems. The correction optical systems are moved on a plane perpendicular to the optical axis, in such a direction that movement of the optical axis is neutralized. A power of the correction optical systems is represented by a “lens sensitivity”. Lens sensitivity corresponds to an effect caused by movement of the correction optical system, the effect which is equivalent to a predetermined amount of angular change of the optical axis, when the correction optical system is moved by a given amount. Note that, the effect is referred to as an “angular changing amount of optical axis” hereinafter.

The correction optical systems are driven by, for example, direct-driven-type-actuators which are provided with a stepping motor and a screw shaft. A rotational movement of the stepping motor is changed to a linear movement on the plane perpendicular to the optical axis and then the liner movement is transmitted to the correction optical systems, by a proper transmission mechanism. A driving pulse signal controls the drive of the direct-drive-type-actuator, and the amount of movement of the correction optical system is defined per pulse. Accordingly, in the optical device, the amount of angular change of optical axis per pulse is defined in accordance with the amount of movement per pulse and the lens sensitivity.

In recent years, it has been required to increase the accuracy of the tremble correction mechanism. Specifically, it is required to move the optical axis smoothly and make the response speed of the tremble correction to the hand tremble faster. It would be desirable to make the angular amount of change of optical axis per pulse smaller, in order to carry out the tremble correction smoothly and minutely. The amount of movement of the correction optical system per pulse may be made smaller, or a correction optical system with a lower lens sensitivity may be utilized, in order to make the angular change of the optical axis per pulse smaller. However, the amount of movement of the correction optical system per pulse is limited by the stepping motor and the structure of the transmission mechanism. Further, if the lens sensitivity of the correction optical system is low, the response speed becomes low, and tremble correction can not follow the hand tremble when the hand tremble is strong.

If the pulse rate of the driving pulse signal is set high, the response speed becomes faster. Note that, the pulse rate is a pulse number of the driving pulse signal per 1 unit period. However, a stepping motor has a least upper bound of the pulse rate by which it can be started without stepping out, with respect to a given torque. If the pulse rate of the driving pulse signal exceeds the least upper bound, there is a possibility that the stepping motor will step out and stop with an abnormal oscillation.

The manner in which the optical axis moves due to the hand tremble is featured below. Namely, the direction in which the optical axis moves due to the hand tremble is frequently changed. Further, when the hand tremble is strong, there is a tendency that the speed of movement of the optical axis will be fast immediately after the direction is changed. Accordingly, if the pulse rate is set higher, in accordance with an increase in the speed of movement of the optical axis, the stepping motor is extremely readily stepped out, immediately after the rotational direction of the stepping motor is changed in a case where the hand tremble is strong. Namely, to increase the response speed by increasing the pulse rate is very limited.

### SUMMARY OF THE INVENTION

Therefore, an object of the present invention is to provide a tremble correcting device, which is able to smoothly correct a focused image tremble, with a high response speed to a hand tremble.

In accordance with an aspect of the present invention, there is provided a tremble correcting device comprising: a correction optical system for correcting a tremble of a focused image of an optical device; a stepping motor that moves the correction optical system in a predetermined direction; a detector that detects an amount of tremble of an optical axis of the optical device; and a controller that generates driving pulse signals to the stepping motor and controls the pulse rate of the driving pulse signal in accordance with the amount of tremble. Accordingly, the correction of the focused image tremble is smoothly carried out. Further, the correction is able to respond to a hand tremble without a delay.

Preferably, the controller sets the pulse rate of the driving pulse signals to within a pull-in torque characteristic area, when either the stepping motor starts, or immediately after the rotational direction of the stepping motor is changed. When the pulse rate is within the pull-in torque characteristic area, the stepping motor generates a torque for moving the correction optical systems without stepping out. Accordingly, the stepping motor is not stepped out at the start of at the change of the rotational direction.

Preferably, the controller comprises: a pulse signal generator that generates a plurality of pulse groups which include a different pulse rate; a pulse number calculator that calculates a necessary pulse number per a predetermined period in accordance with the amount of tremble; and a driving pulse signal generator that selects and outputs one of the plurality of pulse groups based on the necessary pulse number in the predetermined period, as the driving pulse signals. For example, the pulse number calculation is achieved by a microcomputer.

Optionally, the driving pulse signal generator comprises components of hardware, for example, a multiplexer, a counter, a gate and so on, whereby the pulse rate of the driving pulse signal is readily changed with a structural simplicity. The plurality of pulse groups is input to the multiplexer. An output of the multiplexer is input to the counter as a clock, and the necessary pulse number is loaded in the counter by a pulse loader. The gate is opened and passes the output of the multiplexer while the counter counts the necessary pulse number. The output of the multiplexer is input to the stepping motor. Optionally, the counter may be an up-counter or a down-counter. Further, the gate may be an AND gate.

As an embodiment of the tremble correcting device, preferably, the driving pulse signal generator selects one of the plurality of pulse groups whose pulse number in the predetermined period equal to the necessary pulse number, and outputs the selected pulse group for the predetermined period. The driving pulse signal generator includes a plurality of generators that generates a pulse group, and the pulse signal of each of the plurality of generators is output to the multiplexer. The pulse group of the plurality of generators includes a predetermined pulse interval. A pulse number of the pulse group in the predetermined period is different between the plurality of generators. By utilizing the above-mentioned structure, a variety of driving pulse signals can be readily supplied to the stepping motor.

As another embodiment of the tremble correcting device, preferably, the driving pulse signal generator selects a pulse group including a pulse number in the predetermined period which is equal to or more than and nearest to the necessary pulse number, and outputs pulses of the selected pulse group in the predetermined period as the driving pulse signal. The number of output pulses correspond to the necessary pulse number.

Preferably, immediately after the counter counts the necessary pulse number, the gate is closed so that the total number of output pulses of the driving pulse signal coincides with the necessary pulse number.

Preferably, the pulse signal generator includes: a generator that generates a standard pulse group having a predetermined number of pulses in the predetermined period; and a plurality of frequency dividers connected in series whereby each output of the frequency dividers is sequentially divided. The predetermined number of pulses is an integer. Each output of the generator and the frequency dividers is input to the multiplexer. By utilizing this embodiment, the circuit for generating the driving pulse signal is simplified.

### BRIEF DESCRIPTION OF THE DRAWINGS

The objects and advantages of the present invention will be better understood from the following description, with reference to the accompanying drawings, in which:

FIG. 1 is a perspective view showing the positional relationship between optical systems of binoculars, to which a first embodiment, according to the present invention, is applied;

FIG. 2 is a front view of a tremble correction device of the binoculars;

FIG. 3 is a block diagram of a control circuit of the binoculars;

FIG. 4 is a schematic showing one portion of the control circuit of FIG. 3;

FIG. 5 is a graph indicating a characteristic between torque and pulse rate of a stepping motor which is provided in the correction device;

FIG. 6 is a view indicating a truth table which is used in a multiplexer shown in FIG. 4;

FIG. 7 is a flow-chart indicating processes of a main routine performed by a microcomputer shown in FIGS. 3 and 4;

FIG. 8 is a flow-chart indicating processes of a subroutine of a tremble correction in a lengthwise direction;

FIG. 9 is a flow-chart indicating processes of a subroutine of outputting pulse in the lengthwise direction;

FIG. 10 is a flow-chart indicating processes of a subroutine to set a lengthwise-moving-direction flag;

FIG. 11 is a flow-chart indicating processes of a subroutine of compensating a pulse number;

FIG. 12 is a timing chart indicating output signals, output from each element of the circuitry in the first embodiment;

FIG. 13 is a block diagram of a control circuit of a tremble correcting device, to which a second embodiment, according to the present invention, is applied;

FIG. 14 is a circuitry showing one portion of the control circuit of FIG. 13; and

FIG. 15 a timing chart indicating output signal output from each element of the circuitry in the second embodiment.

### DESCRIPTION OF THE PREFERRED EMBODIMENTS

Embodiments according to the present invention will be explained with reference to the figures.

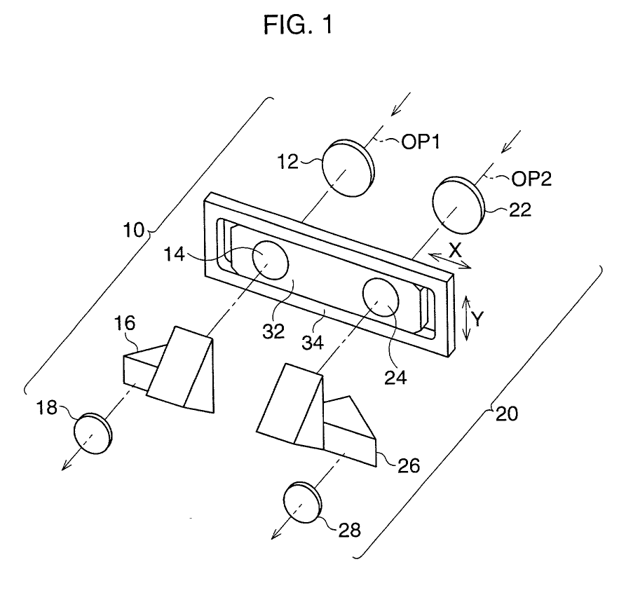

FIG. 1 shows optical systems of binoculars to which a first embodiment according to the present invention is applied. FIG. 1 a perspective view in which the positional relationship between the optical systems of the binoculars is conceptually depicted. The binoculars are provided with a first optical system 10 and a second optical system 20 which respectively correspond to each eye of a user. The first optical system 10 is provided with an objective lens 12, a correction lens 14 which is a correcting optical system, an erecting prism 16 and an eyepiece 18. An optical axis OP1 of the first optical system is shown by a broken line. The structure of the second optical system 20 is similar to that of the first optical system 10. The reference numeral of each element of the second optical system 20 equals ten plus the numeral of the corresponding element of the first optical system 10.

A predetermined interval exists between the optical axis OP1 of the first optical system 10 and the optical axis OP2 of the second optical system 20, and the optical axes OP1 and OP2 are parallel each other. The correction lenses 14 and 24 are unitarily held by a lateral-driving-frame 32. The frame 32 is held by a lengthwise-driving-frame 34 in such a manner that the frame 32 is supported in an opening portion of the frame 34.

The frame 32 is situated perpendicular to the optical axes OP1 and OP2, and the frame 32 is movable in the longitudinal direction thereof, in the opening portion of the frame 34. The direction in which the frame 32 moves is shown by an arrow X. The direction is parallel to a plane on which the optical axes OP1 and OP2 lie, and is perpendicular to the optical axes OP1 and OP2. The direction corresponding to the arrow X is defined as “a lateral direction”.

On the other hand, the frame 34 is movable only in a direction which is perpendicular to the optical axes OP1, OP2 and the lateral direction. The direction in which the frame 34 moves is shown by an arrow Y. The direction corresponding to the arrow Y is defined as “a lengthwise direction”. The frames 32 and 34 are respectively driven by driving mechanisms in the lateral and lengthwise direction. The driving mechanisms are described later.

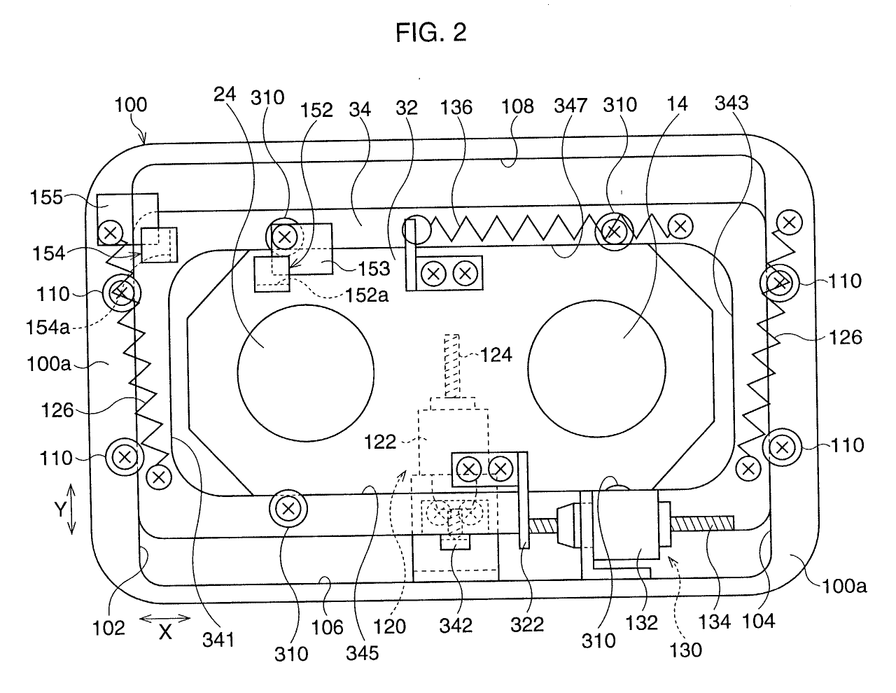

The correction lens 14 and 24 are fixed at a predetermined position in an outer frame (reference numeral 100, see FIG. 2) of the binoculars by the frames 32 and 34, being immovable in the direction along the optical axes OP1 and OP2, and being movable in the lateral and lengthwise directions crossing at a right angle on the plane perpendicular to the optical axes OP1 and OP2.

Usually, as shown in FIG. 1, the correction lenses 14 and 24 are positioned at a standard position in which the optical axis OP1 is coincident with the optical axes of the other optical systems of the optical system 10 and the optical axis OP2 is coincident with the optical axes of the other optical systems of the optical system 20. When the binoculars are subjected to a hand tremble, the correction lenses 14, 24, namely, the frames 32, 34 are relatively moved such that the movement of the optical axes of the binoculars are neutralized.

FIG. 2 is a front view of the correction lenses 14, 24, the lateral-drive-frame 32 and the lengthwise-drive-frame 34 from the side of the objective lenses 12, 22. The driving mechanisms of the correction lenses 14 and 24 will be explained referring to FIG. 2.

The binoculars are provided with the outer frame 100. The frame 100 includes an opening portion, a sectional view of which is approximately rectangular. The frame 34 is placed in the opening portion of the frame 100. The outline of the sectional view of the frame 32 is approximately rectangular. The length of the frame 34 along the lateral direction is approximately equal to the distance between inner walls 102 and 104 of the frame 100. The inner walls 102, 104 are parallel to the lengthwise direction, facing each other, with the frame 34 therebetween. The length of the frame 34 along the lengthwise direction is smaller than the distance between the inner walls 106 and 108 of the frame 100. The inner walls 106, 108 are parallel to the lateral direction, facing each other, with the frame 34 therebetween. The frame 34 is movable between the inner walls 106, 108 in the lengthwise direction, being guided by the inner walls 102, 104.

As shown in FIG. 2, four washers 110 are provided on a side surface 100a of the frame 100. One portion of the peripheral portion of each washer 110 projects in the inner side from the inner walls 102, 104. Note that, four washers are provided on another side surface opposite to the side surface 100a, not being depicted in FIG. 2. The washers 110 on the opposite side surface are placed at positions corresponding to the washers 110 on the side surface 100a. Namely, the frame 34 is held by, and between, the four pairs of washers 110. Accordingly, the frame 34 is prevented from moving along the optical axes OP1 and OP2 by the eight washers.

A direct-driven-type-actuator 120 is fixed on the inner wall 106 of the outer frame 100, the inner wall 106 being placed in the lower side of FIG. 2. The actuator 120 is provided with a stepping motor 122, a screw feeder mechanism (not shown) which converts a rotational driving power of the stepping motor 122 to a liner movement of a screw 124 in the lengthwise direction. The screw 124 extends or retracts based on whether the stepping motor 122 is rotated in a forward or reverse direction. A metal member 342, for pushing the frame 34 in the lengthwise direction, is fixed at a center of the lower side of the frame 34. The metal member 342 is abutted against the tip of the screw 124 from the lower side of FIG. 2.

At left side of the frame 34 in FIG. 2, one end of a spring coil 126 is fixed. Similarly, at right side of the frame 34, one end of a spring coil 126 is fixed. Another end of each spring coil 126 is fixed on the outer frame 100. The frame 34 is urged upward in FIG. 2 by the spring coils 126, so that the metal member 342 is abutted against the tip of the screw 124 at all times. Accordingly, when the screw 124 extends or retracts in the lengthwise direction, the movement of the screw 124 is positively transmitted to the frame 34 through the metal member 342, the frame 34 is relatively moved toward the outer frame 100 in the lengthwise direction by the amount of the movement of the screw 124.

Drive of the frame 32 in the lateral direction is performed by a driving mechanism similar to the driving mechanism of the frame 34. The frame 32 is moved between inner walls 341, 343 parallel to the lengthwise direction of the frame 34, being guided by inner walls 345, 347 parallel to the lateral direction of the frame 34. The frame 32 is prevented from moving along the optical axes OP1 and OP2 by eight washers 310 (only four washers 310 are depicted in FIG. 2).

The frame 32 is driven by a direct-driven-type-actuator 130. The actuator 130 is fixed on the inner wall 106 of the outer frame 100. The actuator 130 is provided with a stepping motor 132 and a screw 134. The screw 134 extends or retracts in the lateral direction based on a rotational direction of the stepping motor 132. A metal member 322 for pushing the frame 32 in the lateral direction is fixed at an approximate center portion of the lower side of the frame 32. The metal member is abutted against the tip of the screw 134 from the left side of FIG. 2. The frame 32 is urged in the right direction of FIG. 2 by a coil spring 136, so that the metal member 322 is abutted against the tip of the screw 134 at all times. When the screw 134 extends or retracts in the lateral direction by the drive of the stepping motor 132, the frame 32 is moved in the lateral direction relative to the frame 34 by the amount of movement of the screw 134.

Note that, the binoculars are provided with sensors for detecting the positional relationship between the correction lenses 14, 24 and the outer frame 100. In other words, the sensors detects if the correction lenses 14, 24 are positioned at the standard position. One of the sensors is a lateral-direction-standard-position-sensor 152 which detects a lateral-direction-standard-position at which the optical axes of the correction lenses 14, 24 lie on a plane on which the optical axes OP1 and OP2 lie, the plane being parallel to the lateral direction. Another of the sensors is a lengthwise-direction-standard-position-sensor 154 which detects a lengthwise-direction-standard-position at which the optical axes of the correction lenses 14, 24 lie on a plane on which the optical axes OP1 and OP2 lie, the plane being parallel to the lengthwise direction.

Namely, when the correction lenses 14, 24 are in the standard position, the correction lenses 14, 24 are simultaneously in the lateral-direction-standard-position and the lengthwise-direction-standard-position.

The sensor 152 is a transmission-type photo-interrupter, which is fixed on the frame 32. The sensor 152 includes a light-emitting element and a photoreceptor element at a hollow portion 152a. Note that the light-emitting element and the photoreceptor element are omitted in FIG. 2. When the frame 32 is moved relative to the frame 34, a thin plate 153, which is fixed on the frame 34, passes in the hollow portion 152a. Namely, the thin plate 153 passes between the light-emitting element and the photoreceptor element. Then, the output level of the sensor 142 changes, when the thin plate 153 intercepts light being output from the light-emitting element. The sensor 152 and the thin plate 153 are positioned such that the output level of the sensor 152 changes when the correction lenses 14, 24 are in the lateral-direction-standard-position.

Similarly, the sensor 154 is a transmission-type photo-interrupter. The output level of the sensor 154 changes when a thin plate 155 intercepts light being output from a light-emitting element of the sensor 154 in a hollow portion 154a. The sensor 154 and the thin plate 155 are positioned such that the output level of the sensor 154 changes when the correction lenses 14, 24 are in the length-direction-standard-position.

As described above, the lateral-direction-standard-position of the correction lenses 14, 24 is detected by the sensor 152 and the lengthwise-direction-standard-position is detected by the sensor 154. The correction lenses 14 and 24 are positioned at the standard positions with respect to the lateral and lengthwise directions, immediately after the binoculars are powered on, or while tremble correction is not carried out.

As described above, the frame 32 or the frame 34 are moved relative to the outer frame 100 by the direct-driven-type actuators 120 and 130. In accordance with the movement of the frame 32 and 34, the correction lenses 14, 24 are unitarily moved.

Amounts of the relative movement of the correction lenses 14 and 24, that is the frames 32 and 34, are determined in accordance with a total pulse number of driving pulse signals of the stepping motors 122 and 132. Also, speeds of the relative movements of the correction lenses 14 and 24 are determined in accordance with a pulse number of the driving pulse signals per unit time. Namely the speeds are determined by a pulse rate (pps (pulses per second)). In the first embodiment, the pulse rate is determined by calculating a pulse number per 1 millisecond, necessary for canceling the tremble of the focused image. This pulse number is referred to as a “necessary pulse number” hereinafter. As the pulse rate is determined based on the necessary pulse number, the movements of the correction lenses 14 and 24, which are equivalents to angular changes of the optical axes OP1 and OP2, can be smoothly carried out to compensate for the hand tremble.

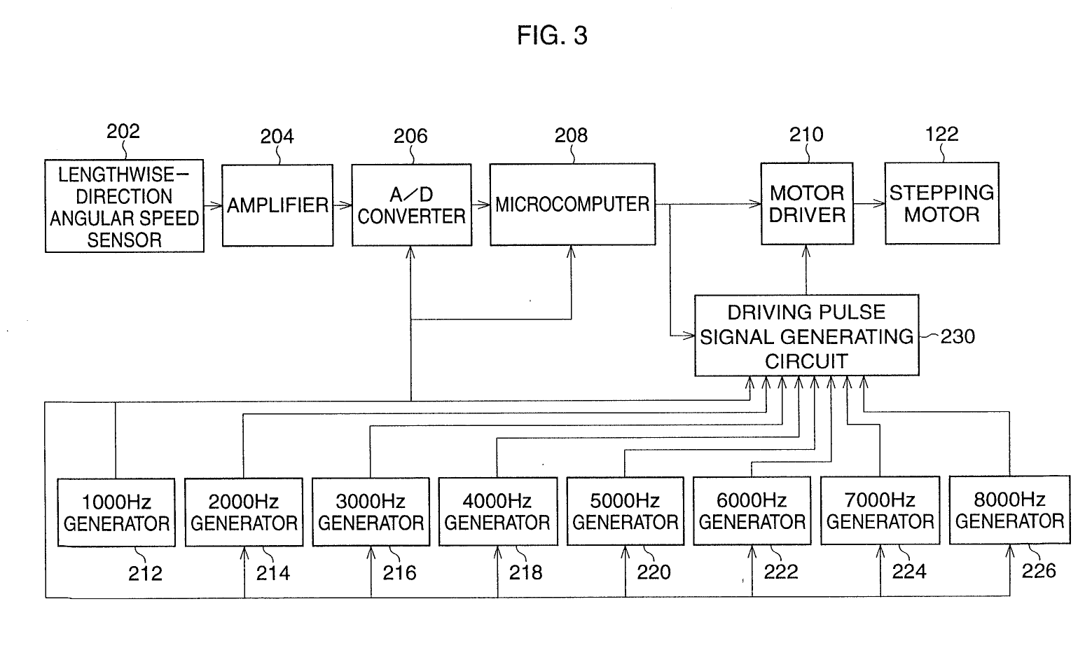

FIG. 3 is a block diagram of a circuit which controls the stepping motor 122 for driving the frame 34. Note that, as the structure of the circuit which controls the stepping motor 132 is similar to the circuit of the stepping motor 122, an explanation of the circuit of the stepping motor 132 will be omitted.

The binoculars are provided with a lengthwise-direction angular speed sensor 202, by which a direction and an angular speed of a tremble of the binoculars, in the lengthwise direction, caused by a hand tremble, is detected. The sensor 202 generates an analog voltage signal which is proportional to the angular speed. Note that, the analog voltage signal is referred to as an “angular speed signal” hereinafter.

After the angular speed signal is amplified by an amplifier 204, the amplified angular speed signal is converted to a digital signal, which is angular speed data, by an A/D converter 206. A first pulse group of 1000 pps is input from a first generator 212 to the A/D converter 206. In the A/D converter 206, the angular speed signal is sampled per 1 millisecond, being synchronized with the first pulse group, so that the angular speed data is obtained. Further, information about the direction of the tremble along the lengthwise direction, namely, plus or minus is added to the angular speed data. The angular speed data is input to a microcomputer 208.

The microcomputer 208 calculates the amount of angular change of the optical axes in the lengthwise direction in a 1 millisecond period, by integrating the angular speed data. Further, the microcomputer 208 calculates the amount of the relative movement of the frame 34, which is necessary to neutralize the tremble of the focused image, in the 1 millisecond period, and also the necessary pulse number in the 1 millisecond which is should be added to the stepping motor 122. Note that, the necessary pulse number is an integer which is not less than 0 and not larger than 8. This operation is repeatedly carried out per 1 millisecond, being synchronized with the first pulse group.

The microcomputer 208 outputs the necessary pulse number which is calculated every 1 millisecond period to a driving pulse signal generating circuit 230. The first pulse group and a second through an eighth pulse group are respectively generated in and output from the first generator 212, a second generator 214, a third generator 216, a fourth generator 218, a fifth generator 220, a sixth generator 222, a seventh generator 224 and an eighth generator 226. The first pulse group through the eighth pulse group are input to the generating circuit 230. Also, a 0 pps signal to ground level (not shown) is input to the generating circuit 230. The 0 pps signal is output when the necessary pulse number is 0. Pulse rates of the first through eighth pulse groups are different from each other. The generating circuit 230 selects one of the first through eighth pulse groups or the 0 pps signal, in accordance with the necessary pulse number. Then, the generating circuit 230 generates driving pulse signals using the necessary pulse number, which are synchronized with the selected pulse group, and outputs to a motor driver 210.

The pulse rates of the first through eighth pulse groups are 1000 pps, 2000 pps, 3000 pps, 4000 pps, 5000 pps, 6000 pps, 7000 pps and 8000 pps respectively. The pulse rates of the first through eighth pulse group are input to the generating circuit 230. With respect to the first through eighth pulse group, a pulse spacing is identical. Note that, the first pulse group, whose pulse width is largest, is input to the second through eighth generators 214 through 226, the A/D converter and the microcomputer 208, as a standard clock signal, so that operation of each component of the circuit is synchronized each other per one first pulse group period, namely 1 millisecond.

For example, when the microcomputer 208 calculates the necessary pulse number per 1 millisecond resulting in “5”, the fifth pulse group of 5000 pps is selected by the generating circuit 230. As the fifth pulse group includes five pulses per 1 millisecond, the pulse number of the fifth pulse group is coincident with the necessary pulse number. Accordingly, when the stepping motor 122 is controlled, based on the fifth pulse group, the stepping motor 122 rotates by five steps during 1 millisecond at a uniform velocity. With respect to other cases, a similar operation is performed. For example, if the necessary pulse number is “2”, the stepping motor 122 rotates by two steps during 1 millisecond at a uniform velocity, being synchronized with the second pulse signal (2000 pps). If the necessary pulse number is “8”, the stepping motor 122 rotates by eight steps during 1 millisecond at a uniform velocity, being synchronized with the eighth pulse group (8000 pps).

As described above, the pulse rate of the driving pulse signal is controlled, based on a step number by which the stepping motor 122 rotates in 1 millisecond, so that the rotational speed and the driving amount of the stepping motor 122 is controlled. Accordingly, the correction lenses 14, 24 can be moved smoothly.

The motor driver 210 controls the drive of the stepping motor 122 based on the input driving pulse signals and a signal instructing the rotational direction of the stepping motor 122, output from the micro computer 208. Namely, the stepping motor 122 rotates in a forward or reverse direction by the necessary pulse number calculated by the microcomputer 208, so that the correction lenses 14 and 24 are moved, and an effect can be obtained, which is equivalent to the predetermined movement of the optical axes OP1 and OP2.

Note that, when the stepping motor 122 starts rotating or changes its rotational direction, there is a possibility that the stepping motor 122 will step out when the pulse rate, corresponding to the necessary pulse number, is within a pull-out torque characteristic area. In order to prevent the stepping motor 122 from stepping out, the microcomputer 208 first selects a pulse signal which has a maximum pulse rate within a pull-in torque characteristic area, then changes the pulse signal such that the pulse rate is incrementally increased.

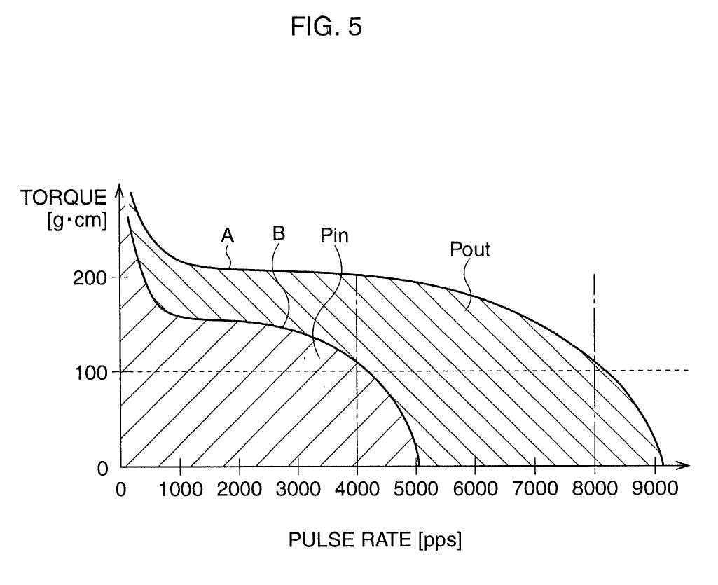

Referring to FIG. 5, it will be explained in particular how to select a pulse signal at the initial start of the stepping motor 122 and at the change of rotational direction of the stepping motor 122. FIG. 5 is a graph indicating a torque-pulse-rate characteristic of the stepping motor 122.

A curve A is a pull-out torque characteristic. The pull-out torque is a largest pulse rate at which the stepping motor 122 can operate without stepping out under a given load, and the pull-out torque characteristic indicates values of the pull-out torque at each load. A curve B is a pull-in torque characteristic. A pull-in torque is a largest pulse rate at which the stepping motor 122 can start without miss stepping under a given load. The pull-in torque characteristic indicates values of the pull-in torque at each load.

An area Pin, which is within the curve B (a hatched area defined by two axes of the graph and the curve B), indicates a pull-in torque characteristic area. An area Pout, which is between the curves A and B (another hatched area defined between the curves A and B) indicates a pull-out torque characteristic area. The eighth pulse group, a pulse rate of which is largest, exists near the outer limit of the pull-out torque characteristic area Pout.

A case will be explained in which the torque necessary for driving the frame 34 in the lengthwise direction is 100 g•cm. In this case, any pulse signals within the pull-in torque characteristic area Pin should be selected in order to prevent the stepping motor 122 from stepping out. Namely, one of either the 0 pps signal or the first through fourth pulse groups should be selected.

If the necessary pulse number is calculated by the microcomputer 208 resulting in “8”, a pulse signal within the pull-in torque characteristic area Pin, having the largest pulse rate, namely the fourth pulse group (4000 pps) is selected first to generate the driving pulse signals. Then, the pulse rate of the driving pulse signals is changed to the fifth pulse group (5000 pps), the sixth pulse group (6000 pps), and the seventh pulse group (7000 pps) in turn at each 1 millisecond, and finally the eighth pulse group (8000 pps) is selected, which corresponds to the calculated necessary pulse number “8”.

As described above, as the pulse rate of the driving pulse signal is changed at each 1 millisecond in the first embodiment, the response speed to a tremble of the focused image becomes faster and the tremble correction is more smoothly carried out. Further, when the stepping motor 122 starts or the rotational direction of the stepping motor 122 is changed, the pulse rate of the driving pulse signal is set to one of the pulse rates within the pull-in torque characteristic area Pin, so that the stepping motor 122 avoid stepping out. Accordingly, even if a correcting optical system whose lens sensitivity is relatively smaller than a conventional correcting optical system is utilized, and the angular amount of change of optical axis per pulse is small, the stepping motor 122 can operate without stepping out and the tremble correction is carried out smoothly and minutely without lowering the response speed to the hand tremble.

Note that, it is preferable that each pulse rate of the second through eighth pulse groups is a multiple of the first pulse group, because the synchronization between the first through eighth pulse groups is readily achieved.

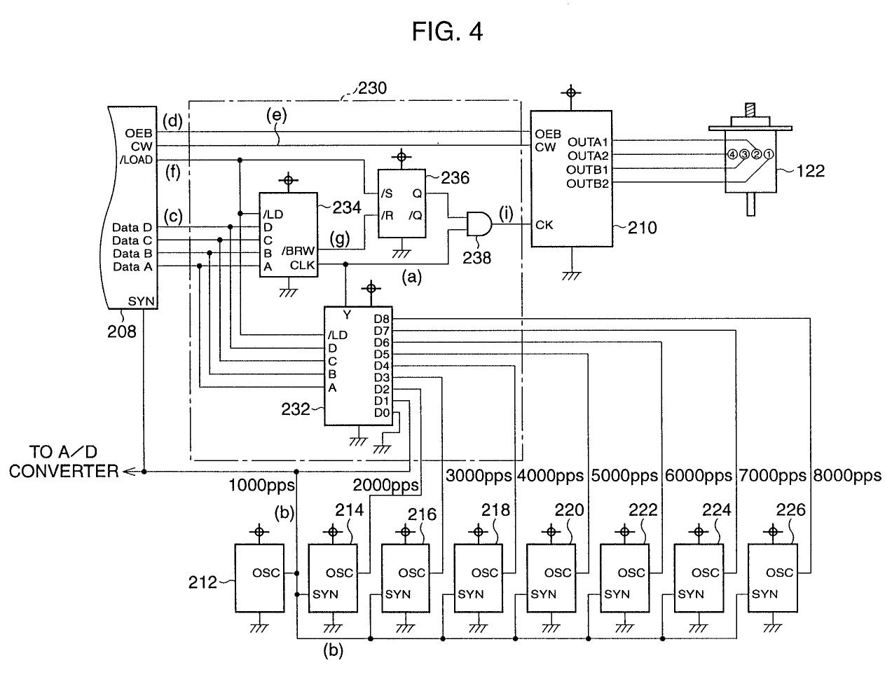

FIG. 4 is a circuit diagram which indicates the structure of the driving pulse signal generator 230 and the structure around the generator 230 in detail. The generator 230 is provided with a multiplexer 232, a down-counter 234, RS (reset-set) flip-flop 236 and an AND gate 238.

The multiplexer 232 is provided with four input terminals which are represented by D, C, B, A. The microcomputer 208 is provided with four ports (Data D, Data C, Data B, Data A). The calculated necessary pulse number, which is four bits data, is input from the four ports to the input terminals D, C, B and A. The first through eight pulse signals are respectively input to input selecting terminals D1 through D8. An input selecting terminal D0 is grounded. The multiplexer 232 selects one of the input selecting terminals DO through D8 based on the four bits data input from the input terminals D, C, B, A.

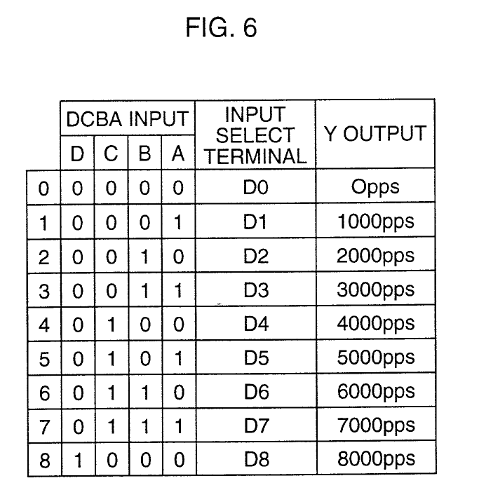

FIG. 6 shows a truth table of the selection in the multiplexer 232. For example, if the necessary pulse number is “4”, bits data of “0100” is input from the microcomputer 208. Then, the multiplexer 232 selects the input selecting terminals D4, and outputs the fourth pulse group of 4000 pps from an output Y.

The output Y is connected to a terminal CLK of the down-counter 234 and the AND gate 238. Further, an output Q of the RS flip-flop 236 is connected to the AND gate 238. When an output level of the output Q is high, the AND gate 238 is opened and the output Y, namely the pulse signals selected by the multiplexer 232, are passed.

The necessary pulse number of 4 bits data is input from the microcomputer 208 to terminals D, C, B, A of the down-counter 234. A load signal is input to a set terminal of the RS flip-flop 236 from the microcomputer 208, so that the output Q becomes high. When the output Q of the RS flip-flop 236 becomes high, the AND gate 238 is opened and the pulse signals passe through the AND gate 238.

The down-counter 234 detects the leading edge of each of the pulse signals output from the output Y of the multiplexer 232, and decreases the necessary pulse number by “1” each time a leading edge is detected. When the necessary pulse number reaches “0”, the down-counter 234 outputs a borrow signal BRW from a terminal BRW to a reset terminal of the RS flip-flop 236. Consequently, the output Q of the RS flip-flop 236 becomes low, the AND gate is closed and the supply of the pulse signal to the motor driver 210 is stopped.

In short, due to the selection of the pulse signal in the multiplexer 232 and the setting of the pulse number in the down-counter 234, a predetermined pulse signal is supplied to the stepping motor 122 by a predetermined pulse number. Note that, the down-counter 234 is utilized for counting the necessary pulse number in the first embodiment, however, the truth table of the four bits data which is input to the terminals D, C, B, A can be changed to another truth table by utilizing an up-counter.

The driving pulse signals are supplied to a clock terminal CK of the motor driver 210 from the AND gate 238. Further, a signal OEB and a signal CW are input to the motor driver 210 from the micro computer 208. An ON/OFF for exciting the stepping motor 122 is set by the signal OEB. The rotational direction of the stepping motor 122 is set by the signal CW.

The stepping motor 122 is a stepping motor of two-phase-excitation type. Namely, the stepping motor 122 is provided with two coils (not shown) for driving a rotor (not shown). Output terminals OUTA1 and OUTA2 are connected to respective ends of one of the coils, and output terminals OUTB1 and OUTB2 are connected to respective ends of another of the coils. The motor driver 210 drives the stepping motor 122 by controlling an amplitude and direction of an electric current which flows through the coils based on the signals OEB and CW.

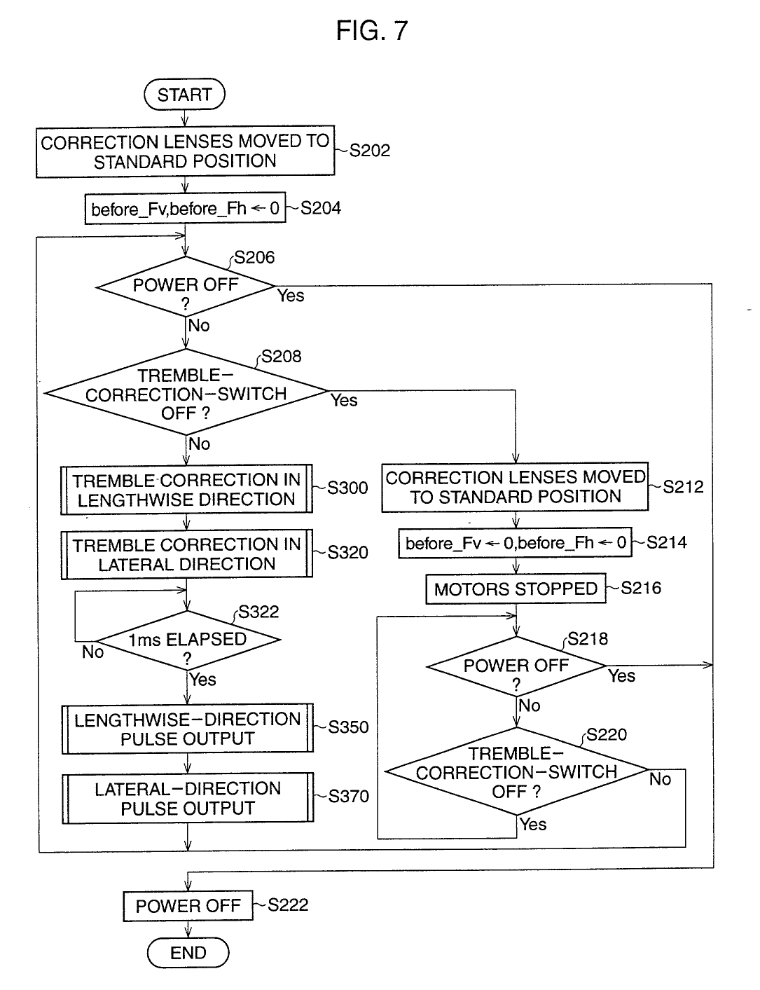

FIG. 7 is a flow-chart which indicates the main routine of the tremble correction performed by the microcomputer 208.

After the binoculars are powered on, at step S202, the correction lenses 14 and 24 are moved to the lateral-direction-standard-position and the length-direction-standard-position by moving the frames 32 and 34 respectively. Namely, the correction lenses are positioned at the standard position.

Next, at step S204, a flag “before_Fv” and a flag “before_Fh” are initialized to “0”. The flag “before_Fv” represents the direction in which the frame 34 was last moved along the lengthwise direction. More precisely, the flag “before_Fv” indicates which direction the stepping motor 122 was rotated last. If the stepping motor 122 was not rotated, the flag “before_Fv” is set to “0”; if the stepping motor 122 was rotated in the forward direction, the flag “before_Fv” is set to “+1”; and if the stepping motor 122 was rotated in the reverse direction, the flag “before_Fv” is set to “−1”.

The flag “before_Fh” represents a direction in which the frame 32 was last moved along the lateral direction. More precisely, the flag “before_Fh” represents which direction the stepping motor 132 was rotated last. Similar to the flag “before_Fh” setting, the flag “before_Fh” can be set to “0”, “+1” and “−1”, based on the previous rotation of the stepping motor 132.

At step S206, it is checked if the power is OFF. If the power is OFF, the program process jumps to step S222. Otherwise, if the power is not OFF, it is checked whether a tremble-correction-switch (not shown) is OFF, with which the binoculars are provided. If the switch is ON, tremble correction is carried out by performing processes from step S300 through step S370. However, if the switch is OFF, tremble correction is not carried out and the processes from step S212 through step S220 are performed.

At step S300, a tremble correction in the lengthwise direction is performed, so that the necessary pulse number of the stepping motor 122 for 1 millisecond period and its rotational direction, which are necessary for performing the tremble correction in lengthwise direction, are calculated. Sequentially, at step S320, a tremble correction in the lateral direction is performed, so that the necessary pulse number of the stepping motor 132 for 1 millisecond and its rotational direction, which are necessary for performing tremble correction in the lateral direction, are calculated.

After the process at step S320 is performed, the pulse numbers and data relating to the rotational direction are temporarily stored in a memory. Then, at step S322 it is determined whether 1 millisecond has elapsed. Step S322 is repeatedly performed until 1 millisecond elapses. After 1 millisecond elapses, the program control proceeds to step S350. Note that, the elapse of 1 millisecond is judged from when the leading edge of the first pulse group, the period of which is 1 millisecond, is detected.

At step S350, a lengthwise-direction pulse outputting process is performed, so that corresponding signals are output in order to drive the stepping motor 122 based on the necessary pulse number and the rotational direction which are stored in the memory. Sequentially, at step S370, a lateral-direction pulse outputting process is performed, so that corresponding signals are output in order to drive the stepping motor 132 based on the necessary pulse number and the rotational direction which are stored in the memory.

After the process of step S370 is completed, the program control returns to step S206. Accordingly, while both the power and the tremble-correction-switch are ON, the lengthwise-direction tremble correction, the lateral-direction tremble correction, the 1 millisecond time elapse check, the lengthwise-direction pulse outputting process and the lateral-direction pulse outputting process are repeatedly performed.

At step S208, when it is judged that the tremble-correction switch is OFF, the correction lenses 14, 24 are moved to the lateral-direction standard position and the lengthwise-direction standard position (step S212), the flags “before_Fv” and “before_Fh” are set to “0” (step S214), and the stepping motors 122, 132 are stopped (step S216). Then, the program control proceeds to step S218.

At step S218, it is determined whether the power is OFF, and at step S220, it is determined whether the tremble-correction switch is OFF. While the power is ON and the switch is OFF, the processes of steps S218 and S220 are repeatedly performed, while keeping the correction lenses 14, 24 at the lateral-direction standard position and the length-wise direction standard position. If it is detected at step S218 that the power is OFF, the program control proceeds to step S222. If it is detected at step S220 that the switch is ON, the program control returns to step S206.

If it is judged at steps S206 or S218 that the power is OFF, a power OFF process of step S222 is performed. In the power OFF process, the correction lenses 14, 24 are moved to the lateral-direction standard position and the lengthwise-direction standard position; the stepping motors 122, 132 are stopped; and then the supply of electric power is stopped at step S222. After the process of step S222 is carried out, the main routine is ended.

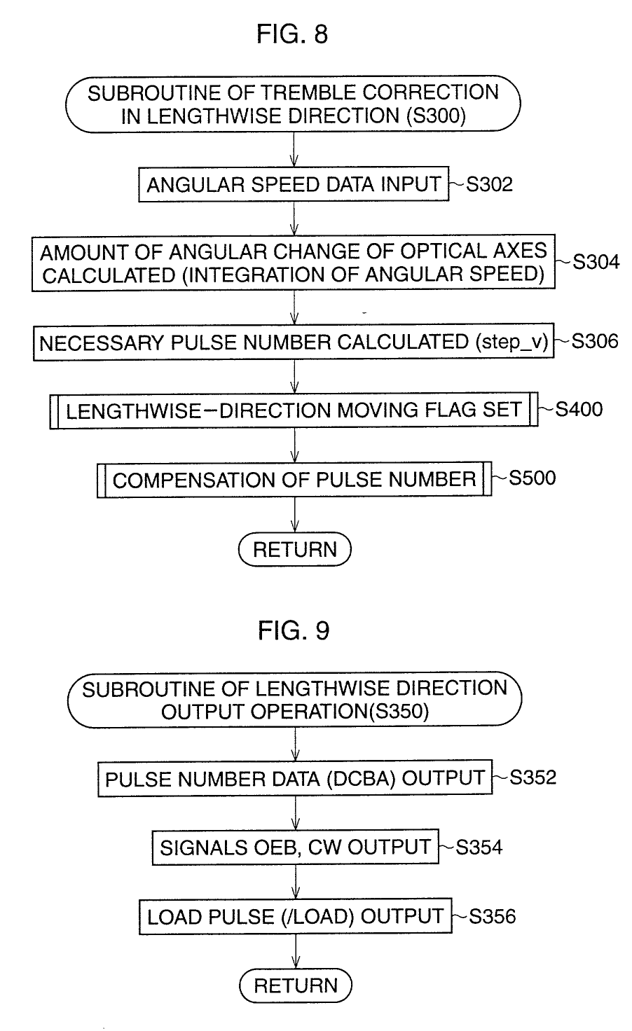

FIG. 8 indicates a flow-chart of the subroutine (step S300, see FIG. 7) in which the tremble correction in the lengthwise-direction is carried out.

First, at step S302, the angular speed data, which is converted to a digital signal by the A/D converter 206, is input to the microcomputer, and at step S304, the amount of angular change of the optical axes in 1 millisecond is calculated by integrating the consecutive angular speed data. Then, a parameter “step_v” for driving the stepping motor 122 is calculated at step S306. The parameter “step_v” is a value in which a sign indicating the rotational direction of the stepping motor is added to the necessary pulse number of the driving pulse signal, each 1 millisecond period, which is supplied to the stepping motor 122. Note that, when the stepping motor 122 should be rotated in the forward direction, a plus sign (+) is added, and when the stepping motor 122 should be rotated in the reverse direction, a minus sing (−) is added. Further, the parameter “step_v” is an integer an absolute value of which is equal to or less than “8”.

Next, at step S400, a subroutine for setting a lengthwise-direction moving direction flag Fv is carried out. The flag Fv is set to either of “0”, “1+1” or “−1”, based on the parameter “step_v” calculated at step S306. Similar to the above-mentioned flag “before_Fv”, the flag Fv indicates the rotational direction of the stepping motor 122. When it is not necessary for the stepping motor 122 to be rotated, the flag Fv is set to “0”. When the stepping motor 122 should be rotated in the forward direction, namely, when the parameter “step_v” is within the range from +1 to +8, the flag Fv is set to “+1”. When the stepping motor 122 should be rotated in the reverse direction, namely, when the “step_v” is within the range from −8 to −1, the flag Fv is set to “−1”. Note that, the flag “before_Fv” indicates the rotational direction in the previous 1 millisecond period, and the flag Fv indicates the rotational direction in the subsequent 1 millisecond period.

Then, at step S500, a subroutine for compensating the pulse number is performed. In this subroutine, if the stepping motor 122 has just started or the rotational direction is changed, the parameter “step_v” is compensated such that the driving pulse signal is set to the largest pulse rate within the pull-in torque characteristic area.

After the subroutine is carried out at step S500, the program control returns to the main routine of FIG. 7, and proceeds to step S320. Step S320 is a subroutine in which the tremble correction in the lateral-direction is carried out. Note that, as the subroutine of step S320 is carried out in a substantially similar manner to the subroutine of step S300, its explanation will be omitted.

FIG. 9 is a flow-chart indicating in detail processes of a subroutine of the lengthwise-direction pulse output performed in step S350 (see FIG. 7).

At step S352, the absolute value of the parameter “step_v”, namely the necessary pulse number, is read to be output as pulse number data of 4 bits (D,C,B,A) to the driving pulse signal generator 230.

Sequentially, at step S354, the signal OEB is set based on the necessary pulse number |step_v|, and the signal CW is set based on the sign of the parameter “step_v”. When the absolute value of the parameter “step_v” equals “0”, the signal OEB is set to a value indicating that the coils of the stepping motor 122 are not excited, and when the absolute value of the parameter “step_v” equals “1” through “8”, the signal OEB is set to a value indicating that the coils of the stepping motor 122 are excited. When the sign of the parameter “step_v” is “+”, the signal CW is set to a value indicating that the stepping motor 122 should be rotated in the forward direction, and when the sign is “−”, the signal CW is set to a value indicating that the stepping motor 122 should be rotated in the reverse direction. The signals OEB and CW are output to the motor driver 210.

Then, at step S356, the load signal is output to the multiplexer 232, the down-counter 234 and the RS flip-flop 236. After the process of step S356 is carried out, this subroutine is ended. Then, the program control returns to the main routine of FIG. 7, and proceeds to step S370 in which the lateral-direction pulse output process is performed. Note that, as the subroutine of step S370 is carried out in a substantially similar manner to the above-mentioned subroutine of step S320, its explanation will be omitted.

In short, while the tremble correction switch is ON, with respect to the lateral and lengthwise directions, a series of the processes for tremble correction are repeated at 1 millisecond intervals, i.e.: the angular speed data of the optical axes due to a hand tremble is read; the necessary pulse number and the rotational direction of the stepping motor is calculated; and the pulse rate of the driving pulse signal is changed.

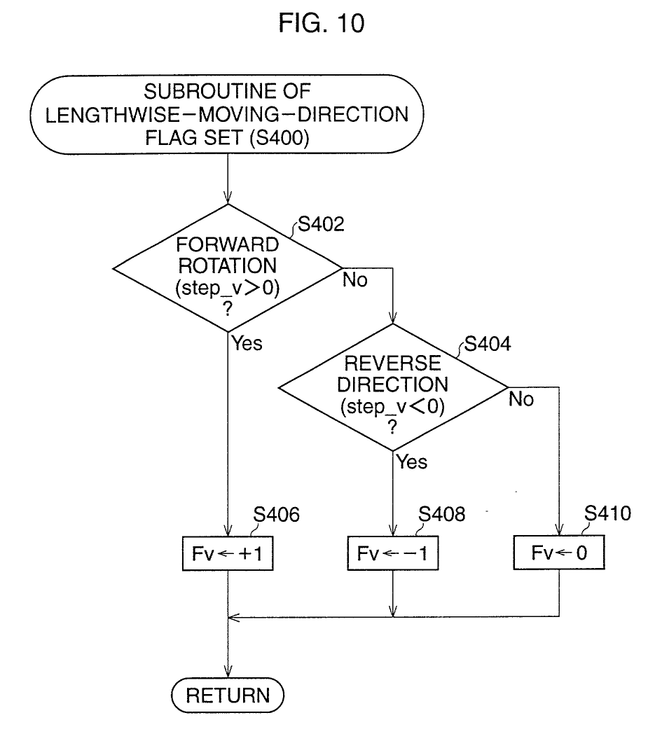

FIG. 10 is a flow-chart indicating in detail the subroutine for setting the lengthwise-direction moving direction flag Fv performed in step S400 (see FIG. 8).

At step S402, it is determined whether the stepping motor 122 should be rotated in the forward direction, namely, it is determined whether the value of the parameter “step_v” is positive. If the value of the parameter “step_v” is not positive, then at step S404, it is determined whether the stepping motor 122 should be rotated in the reverse direction, namely, it is determined whether the value of the parameter “step_v” is negative. If the value of the parameter “step_v” is positive, the program control proceeds to step S406 at which the flag Fv is set to “+1”. If the value of the parameter “step_v” is negative, the program control proceeds from step S404 to step S408, the flag Fv is set to “−1”. If the value of the parameter “step_v” is neither positive nor negative, namely if the value of the parameter “step_v” is “0”, the program control proceeds from step S404 to step S410 at which the flag Fv is set to “0”.

As described above, after the flag Fv, indicating the direction in which the frame 34 should be moved, is set to “+0”, “−1,” or “0”, this subroutine is ended. Then, the program control proceeds to the subroutine for compensating the pulse number.

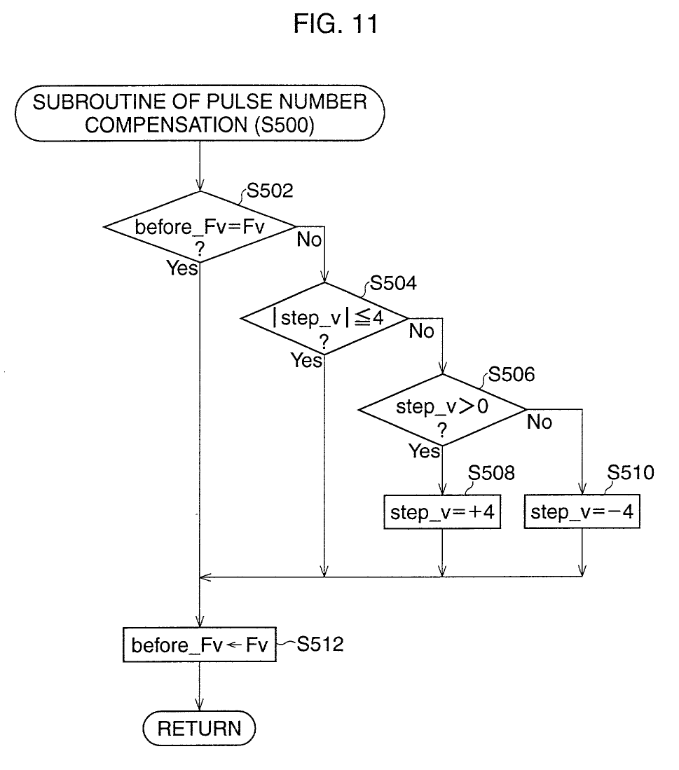

FIG. 11 is a flow-chart indicating in detail the subroutine for compensating the pulse number, which is performed at step S500 (see FIG. 8).

At step S502, it is determined whether the value of the flag Fv is identical with the value of the flag “before_Fv”, namely it is determined whether the rotational direction in which the stepping motor 122 should be rotated is identical with the previous rotational direction in which the stepping motor 122 was rotated. If the value of the flag Fv is not identical with the value of the flag “before_Fv”, the program control proceeds to step S504. At step S504, it is determined whether the necessary pulse number |step_v| is equal to or less than “4”, namely the pulse rate corresponding to the necessary pulse number |step_v| is within the pull-in torque characteristic area. If the rotational direction is identical with the previous rotational direction, the program control proceeds to step S512 without compensating the parameter “step_v”. Also, immediately after the stepping motor 122 starts or when the rotational direction of the stepping motor 122 is changed, the program control proceeds to step S512 without compensating the parameter “step_v”, if the pulse rate is within the pull-in torque characteristic area.

If the value of the flag Fv is not identical with the value of the flag “before_Fv” and the necessary pulse number |step_v| is equal to or more than “5”, it is judged that the pulse rate is within the pull-out torque characteristic area, immediately after the stepping motor 122 starts or the rotational direction in which the stepping motor 122 is changed. Accordingly, by the processes from step S506 through step S510, the parameter “step_v” is compensated such that the pulse rate is changed to be within the pull-in torque characteristic area. At step S506, it is judged whether the parameter “step_v” is positive or negative. If the parameter “step_v” is positive, the value of the parameter “step_v” is compensated to be “+4” at step S508, and if the parameter “step_v” is negative, the value of the parameter “step_v” is compensated to be “−4” at step S510.

The necessary pulse number |step_v| per 1 millisecond is variable between 0 and 8. However, as described above, if the necessary pulse number |step_v| is within the pull-out torque characteristic area, namely the value of |step_v| is 5, 6, 7 or 8, at the start of the stepping motor 122 or at the change of the rotational direction in which the stepping motor 122 is rotated, the necessary pulse number |step_v| is compensated to be “4” which is the largest value within the pull-in torque characteristic area. After that, the program control proceeds to step S512. At step S512, the flag “before_Fv” is updated and set to the value of the flag Fv which indicates the current direction in which the stepping motor 122 is rotating. Then, this subroutine is ended.

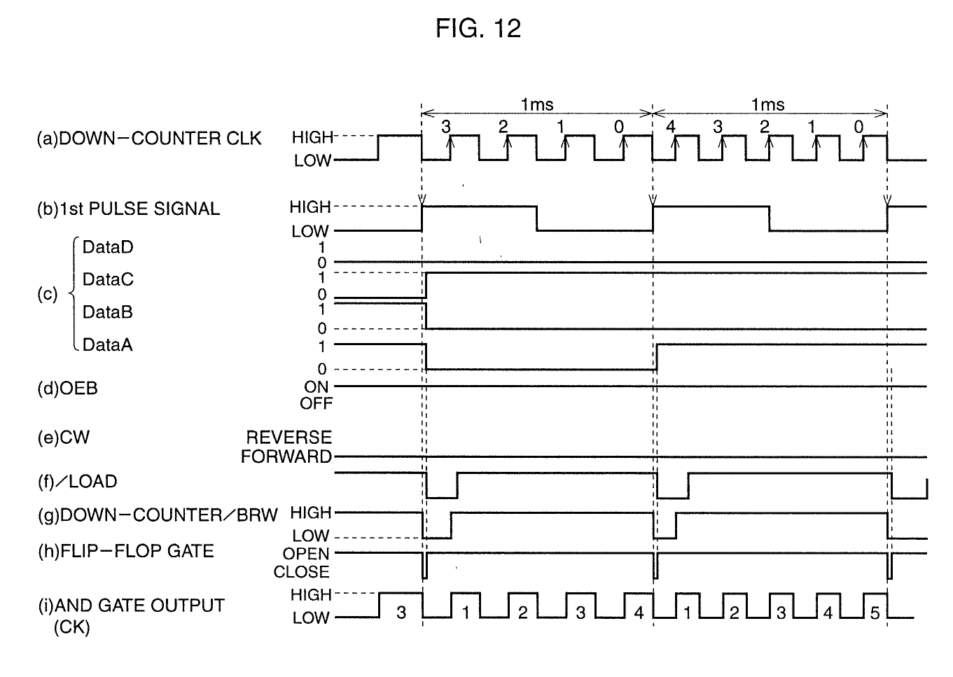

FIG. 12 is a timing-chart indicating the signal levels output from each element of the circuit of FIG. 4. In FIG. 12, the change of signal level output from the elements of the circuit is shown, when the fourth pulse group (4000 pps) and the fifth pulse group (5000 pps) is sequentially selected by the multiplexer 232 each 1 millisecond. Namely, FIG. 12 shows a condition in which the correction lenses 14 and 24 are moved in one direction, gradually increasing its moving speed.

A row (a) represents the pulse signal input to the terminal CLK of the down-counter 234, namely the output signal output from the output Y of the multiplexer 232. Numerals shown on arrows indicating the leading edges of the pulses are values counted by the down-counter 234. A row (b) indicates that sampling is carried out by the A/D converter 206 each time the first pulse group rises.

A row (c) shows change of data of four bits which indicates the necessary pulse number |step_v| in 1 millisecond determined by the microcomputer 208. When the necessary pulse number |step_v| is “4”, Data D is “0”, Data C is “1”, Data B is “0” and Data A is “0”. When the necessary pulse number |step_v| is “5”, Data D is “0”, Data C is “1”, Data B is “0” and Data A is “1”.

A row (d) indicates the level of the signal OEB, and a row (e) indicates the level of the signal CW. As shown by the row (d), the signal OEB is consistently high. Namely, the stepping motor 122 is consistently excited. Further, as shown by the row (e), the signal CW is continuously low. Namely, the direction in which the stepping motor 122 is rotated is constantly forward.

A row (f) indicates the level of the load signal output from the microcomputer 208. The microcomputer 208 changes the load signal to a low level for a predetermined time each time it detectes the first pulse group rise.

Each time the rise of the first pulse group is detected, the microcomputer 208 sets the outputs of the control ports Data D, Data C, Data B and Data A, and each respective levels for the signals OEB and CW and the load signal.

The multiplexer 232 and the down-counter 234 latch data output from the four ports Data D, Data C, Data B and Data A at the trailing edge of the load signal, whereby the pulse number is preset in the multiplexer 232 and the down-counter 234. A row (g) indicates a waveform of the borrow signal BRW. The down-counter 234 changes the level of the borrow signal BRW to a low level, at the trailing edge of a pulse which is counted as “0”. A row (h) indicates the waveform of the output Q of the RS flip-flop 236. The RS flip-flop 236 changes the level of the output Q to a low level at the trailing edge of the borrow signal BRW.

A row (i) indicates the pulse signals which pass the AND gate 238. As shown by the row (i), it is understood that all pulses of the selected signal of the row (a) pass the AND gate 238. The pulse signals which pass the AND gate 238 are input to the clock terminal CK of the motor driver 210 as the driving pulse signals.

As described above, according to the first embodiment of the present invention, the microcomputer 208 and the motor driver 210 are connected through the driving pulse signal generating circuit 230, which selects the pulse signal from among the eight generators, whereby the pulse width and pulse rate of the driving pulse signals are readily changed. Accordingly, the stepping motor 122 is able to be rotated much more smoothly.

In the first embodiment, the pulse numbers for a predetermined time (1 millisecond) of the 0 pps signal and the first through the eighth pulse groups are respectively set to “0” through “8”. The pulse numbers are respectively identical with the nine levels of the necessary pulse number set by the microcomputer 208. Accordingly, the driving pulse signal generating circuit 230 can rotate the stepping motor 122 by a desired pulse number at a desired speed, by selecting and changing the driving pulse signals between the 0 pps signal and the first through the eighth pulse groups in accordance with the condition of the stepping motor 122.

Also, in the first embodiment, counting the pulse number and outputting the data are carried out by the driving pulse signal generating circuit 230. Namely, the microcomputer 208 is required only to output the necessary pulse number of four bits data, the signals OEB, CW and the load signal. Accordingly, in the microcomputer 208, the pulse number calculation for the next 1 millisecond period can be started immediately after the calculation for the previous 1 millisecond period is completed.

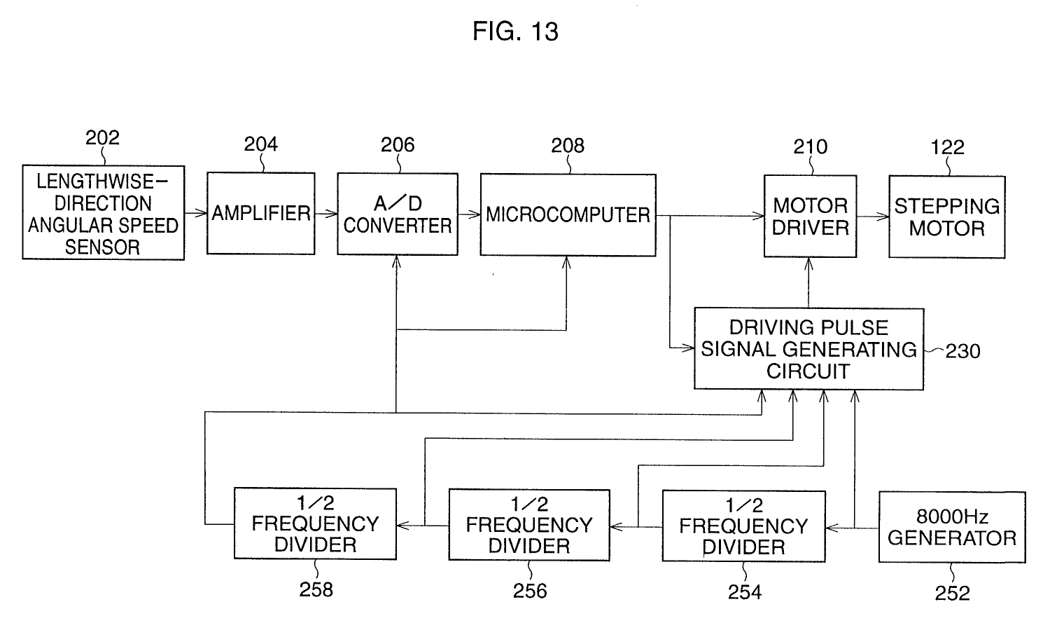

Referring to FIGS. 13 through 15, a second embodiment according to the present invention will be explained. In FIGS. 13 through 15, components utilized in the first embodiment, which are identical in the second embodiment, share the same reference numerals, and the explanations of those components will be omitted.

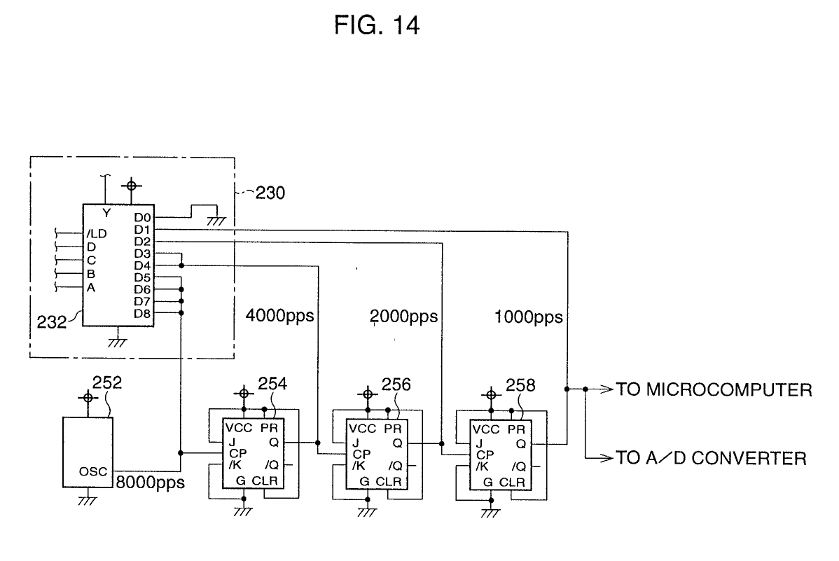

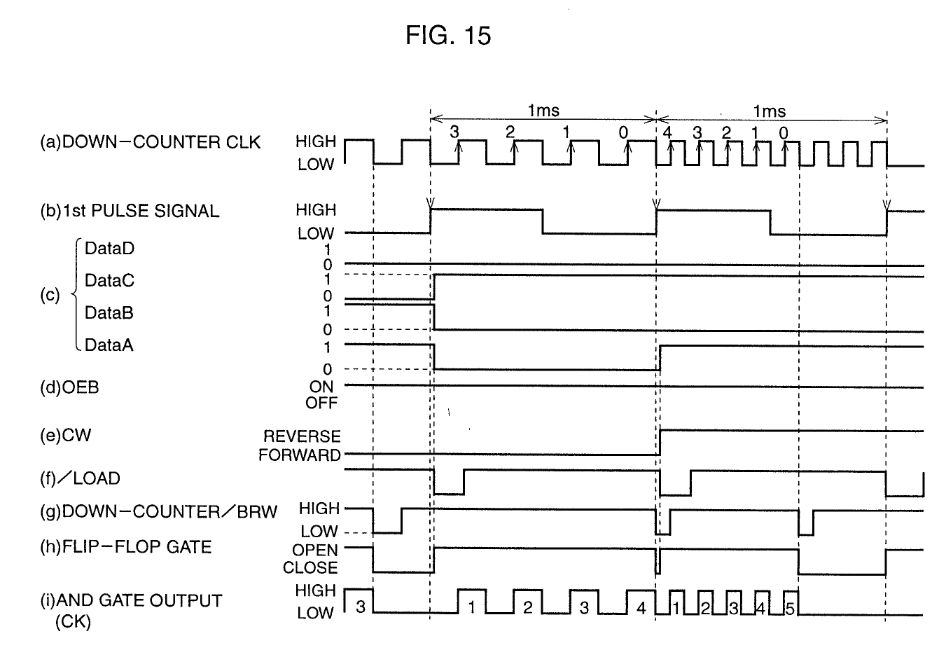

FIG. 13 is a block diagram of a circuit which controls the stepping motor 122, corresponding to FIG. 3 of the first embodiment. FIG. 14 is a circuit diagram which indicates a structure of the driving pulse signal generator 230 and a structure around the generator 230 in detail, corresponding to FIG. 4 of the first embodiment. In FIG. 14, elements relating to the first embodiment and depicted in FIG. 4 are omitted. FIG. 15 is a timing-chart indicating a signal level output from each element of the circuit of FIG. 14, corresponding to FIG. 12 of the first embodiment.

In the second embodiment, the circuit which controls the stepping motor 122 is provided with only one generator 252 for generating the pulse signal. Three one-half frequency dividers are connected in series to the output of the generator 252. The one-half frequency dividers are JK flip-flops 254, 256 and 258. The output pulse of the generator 252 is sequentially divided one-half by the three JK flip-flops 254, 256 and 258. Accordingly, in comparison with the first embodiment, a decrease in a number of components of the circuit is achieved and the structure of the circuit is simplified.

The pulse rate of the pulse signal output from the generator 252 is 8000 pps. The pulse rates of the pulse signals output from the JK flip-flops 254, 256 and 258 are respectively 4000 pps, 2000 pps and 1000 pps. Accordingly, the four kinds of pulse signals 8000 pps, 4000 pps, 2000 pps and 1000 pps are input to the multiplexer 232. Note that, all of the signals input to the multiplexer 232 are synchronized, as they are generated by dividing the output signal of the generator 252.

If the necessary pulse number |step_v| is determined to be “3”, namely if the four bits data input to the input terminals D, C, B, A indicates “3”, the multiplexer 232 selects the input selecting terminal D3. However, as shown in FIG. 14, the pulse signal 4000 pps is input to the terminal D3 through the frequency divider 254. Accordingly, in the second embodiment, if the necessary pulse number |step_v| is determined to be “3”, the borrow BRE signal is output from the down-counter 234 (see FIG. 4) after the third pulse is counted, so that the AND gate 238 (see FIG. 4) is closed and the last pulse (the fourth pulse) in the 1 millisecond period is not output. Consequently, the pulse signal 4000 pps, from which one pulse is omitted in the 1 millisecond period, is input to the motor driver 210 as a driving pulse signal.

In other words, immediately after the down-counter 234 counts the necessary pulse number |step_v|, the AND gate 238 is closed so that the total number of output pulses from the circuit 230 of the driving pulse signal coincides with the necessary pulse number.

Similarly, if the necessary pulse number |step_v| is determined to be “5”, “6” or “7”, the output Y output from the multiplexer 232 is the pulse signal of 8000 pps, from which three, two or one pulse is omitted in 1 millisecond period.

Namely, in the second embodiment, the generating circuit 230 selects a pulse signal including a pulse number, which is equal to or more than and nearest to the necessary pulse number. Then, the generating circuit 230 outputs pulses from among the selected pulse signal, in the 1 millisecond period, by a number corresponding to the necessary pulse number.

In FIG. 15, rows (a), (b), (c), (d), (e) and (f) respectively indicate the pulse signal input to the terminal CLK of the down-counter 234, the A/D convert timing of the A/D converter 206, the change of data of four bits which indicates the necessary pulse number |step_v|, the level of the signal OEB, the level of the signal CW, and the level of the load signal. A row (g) indicates the borrow signal BRW, and a row (h) indicates the opened or closed state of the AND gate (the AND gate is opened when the level is high). A row (i) indicates the pulse signal which passes the AND gate 238.

As apparent from FIG. 15, if the parameter “step_v” is set to “5”, “0” is counted at the fifth pulse by the down-counter 234. The borrow signal BRW is changed to a low level at the trailing edge of the fifth pulse, so that the AND gate 238 is closed and the last three pulses are omitted.

As described above, in the second embodiment, the pulse rate of the driving pulse signal is changed step by step, and if the necessary pulse number |step_v| is “3”, “5”, “6” or “7”, the pulses are out put early in the 1 millisecond period. Accordingly, with respect to the smooth operation of the tremble correction device, the first embodiment is preferable, however, in the second embodiment, the structure of the circuit is simplified. Accordingly, a reduction in a manufacturing costs is achieved due to a decrease in the number of components, and electric power is saved, increasing battery life.

Note that, also in the second embodiment, when the stepping motor 122 starts, or immediately after the rotational direction of the stepping motor 122 is changed, the pulse rate of the driving pulse signal is set to be within the pull-in torque characteristic, then the pulse rate of the driving pulse signal is sequentially changed in accordance with the speed of the hand tremble. Accordingly, the stepping motor 122 starts without stepping out, and when the hand tremble is strong, the response speed can be improved by setting the pulse rate higher. Consequently, if a correction lens, the lens sensibility of which is relatively low, is utilized in order to make the amount of angular change of the optical axis per pulse smaller, the tremble correction can be carried out smoothly and minutely without compromising a the response speed of the tremble correction to the hand tremble.

As described above, according to the present invention, the tremble correction can be carried out smoothly and minutely with maintaining the response speed rate of the tremble correction.

The present disclosure relates to subject matter contained in Japanese Patent Application No. P2000-116237 (filed on Apr. 18, 2000) which is expressly incorporated herein, by reference, in its entirety.

1. A tremble correcting device comprising:
a correction optical system for correcting a tremble of a focused image of an optical device;
a stepping motor that moves said correction optical system in a predetermined direction;
a detector that detects an amount of tremble of an optical axis of said optical device; and
a controller that generates driving pulse signals of said stepping motor and controls a pulse rate of said driving pulse signals in accordance with said amount of tremble.

2. The tremble correcting device of claim 1, wherein said controller sets said pulse rate of said driving pulse signals to be within a pull-in torque characteristic area, when said stepping motor starts or immediately after a rotational direction of said stepping motor is changed.

3. The tremble correcting device of claim 1, wherein said controller comprises:
a pulse signal generator that generates a plurality of pulse groups which include a different pulse rate;
a pulse number calculator that calculates a necessary pulse number per a predetermined period in accordance with said amount of tremble;
a driving pulse signal generator that selects and outputs one of said plurality of pulse groups based on said necessary pulse number in said predetermined period, as said driving pulse signals.

4. The tremble correcting device of claim 3, wherein said driving pulse signal generator comprises:
a multiplexer to which said plurality of pulse groups is input;
a counter to which output of said multiplexer is input as a clock;
a pulse loader which loads said necessary pulse number in said counter;
a gate which is opened and passes the output of said multiplexer while said counter counts said necessary pulse number.

5. The tremble correcting device of claim 4, wherein said driving pulse signal generator selects one of said plurality of pulse groups whose pulse number in said predetermined period is equal to said necessary pulse number, and outputs said selected pulse group for said predetermined period.

6. The tremble correcting device of claim 5, wherein said driving pulse signal generator includes a plurality of generators that generates a pulse group, and the pulse signal of each of said plurality of generators is output to said multiplexer, said pulse group of said plurality of generators having a predetermined pulse interval and a pulse number of said pulse group in said predetermined period being different between said plurality of generators.

7. The tremble correcting device of claim 4, wherein said driving pulse signal generator selects a pulse group including a pulse number in said predetermined period which is equal to or more than and nearest to said necessary pulse number, and outputs pulses of said selected pulse group in said predetermined period as said driving pulse signal, a number of said output pulses corresponding to said necessary pulse number.

8. The tremble correcting device of claim 7, wherein immediately after said counter counts said necessary pulse number, said gate is closed so that a total number of output pulses of said driving pulse signal coincides with said necessary pulse number.

9. The tremble correcting device of claim 7, wherein said pulse signal generator includes:
a generator that generates a standard pulse group having a predetermined number of pulses in said predetermined period, said predetermined number of pulses being an interger; and
a plurality of frequency dividers connecting in series whereby each output of said frequency dividers is sequentially divided, and
each output of said generator and said frequency dividers is input to said multiplexer.

10. A tremble correcting device comprising:
a correction optical system for correcting a tremble of a focused image of an optical device;
a stepping motor that relatively moves said correction optical system in a predetermined direction;
a detector that detects an amount of tremble of an optical axis of said optical device; and
means for controlling a pulse rate of driving pulse signals of said stepping motor in accordance with said amount of tremble, after generating said driving pulse signals.

11. The tremble correcting device of claim 10, wherein said controlling means comprises:
means for generating a plurality of pulse groups a pulse rate of which is different from each other;
means for calculating a necessary pulse number for canceling said amount of tremble, per a predetermined period;
means for selecting one of said pulse groups based on said necessary pulse number; and
means for outputting said selected one of said pulse groups per said predetermined period.
